(19) United States
(12) Patent Application Publication
(10) Pub. No.: US 2006/0142026 A1
(43) Pub. Date: Jun. 29, 2006

(54) Remote operation and maintenance center with location based services

(76) Inventor: Mouayad J. Al-Baghdadi, Buffalo Grove, IL (US)

Correspondence Address: POSZ LAW GROUP, PLC, 12040 SOUTH LAKES DRIVE, SUITE 101, RESTON, VA, 20191, US

(21) Appl. No.: 11/023,929

(22) Filed: Dec. 28, 2004

(51) Int. Cl. H04Q 7/20

(52) U.S. Cl. 455/456.3; 455/456.1

(57) ABSTRACT

A method and systems for modifying one or more parameters of one or more base stations includes establishing a connection (113) between an operation and maintenance center (OMC) (101) and a communication device (111). Information is exchanged from the communication device (111) to the OMC (101) representative of a location of the communication device (111). Parameters are exchanged from the OMC (101) to the communication device (111), the parameters having information corresponding to a state of base station(s) (109a-c) adjacent to the location. One or more modifications are exchanged, the modification(s) reflecting a change to at least one of the parameters. A download of the parameter to the base station(s) (109a-c) is facilitated.

### FIELD OF THE INVENTION

The present invention relates in general to wireless networks, and more specifically to an operation and management control center.

### BACKGROUND OF THE INVENTION

In today's systems, field engineers collect vital system measurements in order to fine-tune a number of system parameters affecting performance of a wireless network. For example, conventional methods for identifying an appropriate cell access range require drive testing. In a drive testing process, technicians drive through areas in proximity to various base stations with equipment configured to study network connectivity, and they collect data regarding base stations, cell sites and connectivity.

Two general strategies or methods of drive testing and analysis are conventionally provided. One traditional method of drive testing is manual. It requires a technician to drive to the problem area and collect data and interpret it on the spot or manually bring the data back to the office for analysis. Another method, which is partially automated, can combine manual drive testing and analysis with automatic data analysis. In the partially automated method, data is collected via drive testing and can be stored on a centralized file server.

After analyzing the data that is collected, field engineers or other personnel may decide that it is desirable to adjust one or more base station parameters. Results can be relayed to a system operator at the operation and maintenance center (OMC) to fine-tune relevant parameters, where the OMC is a location used to operate and maintain a wireless network. An OMC-R (radio portion of the OMC) downloads the changed parameters to the base station(s).

Field engineers can then repeat the drive test to collect additional measurements. With the additional measurements, the field engineers can verify the impact of the changed parameters on the wireless network. This process can be repeated many times until the desired result is obtained.

Communication network problems relating to cell size can increase where the density and number of cells are increased. As communication technologies evolve, more testing may be needed to ensure that a desired level of quality is achieved. However, the conventional process for fine-tuning system parameters can be time consuming, labor intensive, and expensive.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a diagram illustrating a simplified and representative environment associated with a remote operation and maintenance center and exemplary wireless networks in accordance with various exemplary embodiments;

FIG. 2 is a block diagram illustrating portions of an exemplary remote operation and maintenance center in accordance with various exemplary embodiments;

FIG. 3 is a block diagram illustrating portions of an exemplary infrastructure device, e.g., an operation and maintenance center, in accordance with various exemplary embodiments;

FIG. 4 is a flow chart illustrating an exemplary remote operation and maintenance center process in accordance with various exemplary embodiments; and

FIG. 5 is a flow chart illustrating an exemplary operation and maintenance center process in accordance with various exemplary and alternative exemplary embodiments.

### DETAILED DESCRIPTION

In overview, the present disclosure concerns wireless communications networks for supporting devices or units, often referred to as communication units, such as cellular phone or two-way radios. These communication units can be associated with a communication system such as an Enterprise Network, a cellular Radio Access Network, or the like. Such communication systems may further provide services such as voice and data communications services. More particularly, various inventive concepts and principles are embodied in systems, communication infrastructure devices, communication units, and methods therein for remotely managing a communication network.

It should be noted that the term communication unit as used herein can include a subscriber unit, wireless subscriber unit, wireless subscriber device or the like. Each of these terms denotes a device that can be associated with a user and can include a wireless mobile device that may be used with a public network, for example in accordance with a service agreement, or within a private network such as an enterprise network. Examples of such units include personal digital assistants (PDA), personal assignment pads, and personal computers equipped for wireless or wireline operation, a cellular handset or device, or equivalents thereof. In addition, the designation “operation and maintenance center” (OMC) as used herein is intended to include one or more computers used to operate and maintain a cellular network, including generally controlling a modification and download of parameters to base stations (generally performed by an OMC-R, or radio portion of the OMC, which can communicate with the base stations via the communication network).

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as one or more processors and software therefore or application specific ICs. Where appropriate, the processor can be, for example, a general purpose computer, can be a specially programmed special purpose computer, can include a distributed computer system, and/or can include embedded systems. Similarly, where appropriate, the processing could be controlled by software instructions provided by a computer-readable medium on one or more computer systems or processors, or could be partially or wholly implemented in hardware. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to improve the process of managing communication network performance via a communication device. Moreover, the communication device advantageously can be operated in the field.

Further in accordance with exemplary embodiments, a communication device, such as a laptop, PDA, mobile telephone, etc. can be equipped with a communication interface appropriate for communicating with an OMC-R, to act as a remote OMC-R. The communication device communicates with the OMC-R in a way that allows the communication device restricted privileges. The communication device can change various location-specific parameters, and advantageously can be operated in the field. This can reduce the need for field engineers to relay information back and forth with the system operators. In accordance with one or more embodiments, various changes to parameters can be disallowed based on, e.g., the location of the communication device.

Referring now to FIG. 1, a diagram illustrating a simplified and representative environment associated with a remote operation and maintenance center (OMC) and exemplary wireless networks in accordance with various exemplary embodiments will be discussed and described. In overview, a representative communication network illustrated herein includes, e.g., an OMC-R 101, communicating with one or more routers 103. The router 103 communicates with one or more base station controllers 107. The base station controller 107 communicates with one or more base stations, herein represented by first, second and third sites 109a-c. Conventionally, a communication network also includes a mobile switching center 105, generally utilized to control switching a call between a mobile and a switching network, as well as other devices which are omitted to avoid obscuring the discussion.

Also provided is a remote OMC-R 111, e.g., which in the illustrated example is included in a communication device. The remote OMC-R can establish a connection 113 to the OMC-R 101. As in the example, the connection 113 can be a direct connection from the remote OMC-R 111 to the OMC-R 101, e.g., a remote log-in, a dial-up connection, etc. However, one or more embodiments provide that the connection 113 can include a wireless connection, e.g., to one or more of the sites 109a-c and further utilizing a standard connection in the wireless network to communicate with the OMC-R 101.

In overview, the communication device, e.g., the remote OMC-R 111, can provide for establishing a connection, e.g., the illustrated connection 113, to the OMC 101. Further, the communication device can provide for transmitting information to the OMC 101 representative of a location of the communication device. In addition, the communication device can receive parameters from the OMC 101, where the parameters are responsive to the location; further, the parameters can have information corresponding to a state of one or more base stations, e.g., the first site 109a, adjacent to the location. The communication device can provide for modifying one or more parameters of the above mentioned parameters to create one or more modifications. Further, the communication device can transmit the modification(s) to the OMC 101.

Similarly, in overview, the OMC 101 can support the modifying of the parameters of base station, in accordance with the connection 113 and instructions from the remote OMC-R 111. The OMC 101 can support the establishing of a remote connection 113 to the communication device, e.g., remote OMC-R 111. In accordance with one or more embodiments, the connection is initiated by the remote OMC-R 111, however, alternative embodiments provide that the connection can be initiated by the OMC 101. When the connection 113 is established, the OMC 101 provides for receiving information from the communication device representative of a location of the communication device. The OMC 101 can determine parameters corresponding to the location, where the parameters have information corresponding to a state of one or more base stations adjacent to the location, e.g., the first site 109a. The OMC 101 can provide for transmitting the parameters to the communication device. Further, the OMC 101 can provide for receiving one or more modifications of one or more of the parameters. Also, the OMC 101 can provide for downloading the modification(s) to the base station(s). The downloading can be in response to the modifications received from the communication device. When the OMC 101 downloads the parameters, the parameters are transmitted using conventional techniques, e.g., including being transmitted to the router 103, from the router 103 to the base station controller 107, and from the base station controller 107 to the appropriate base stations, e.g., first site 109a, second site 109b, and/or third site 109c. In essence, the OMC 101 provides the communication device 111 with control over modifying and downloading various parameters. Further details are provided below.

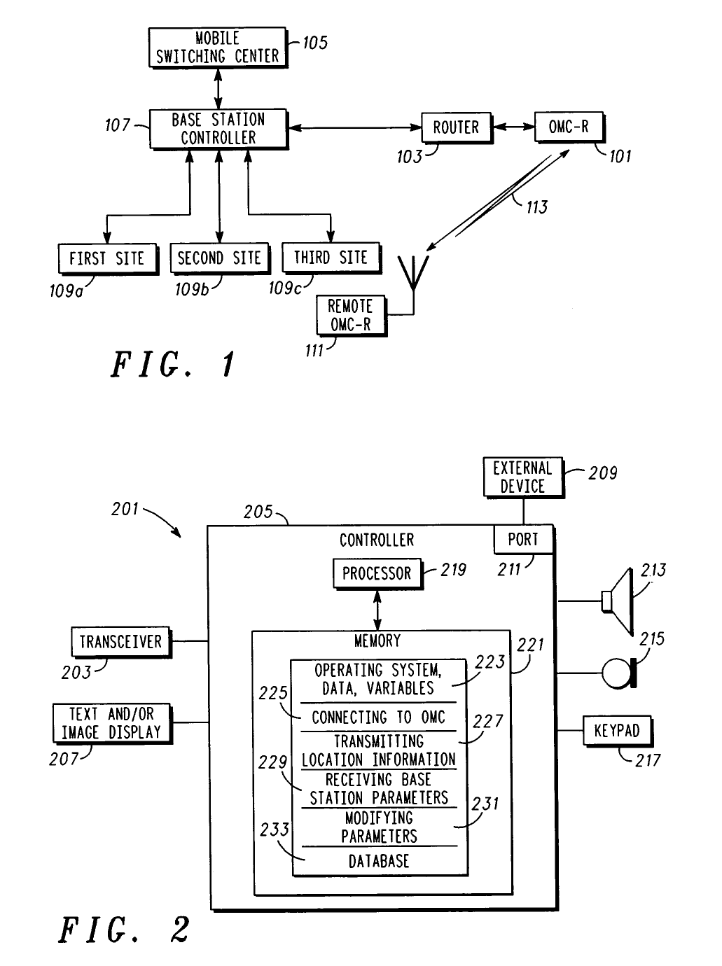

Referring now to FIG. 2, a block diagram illustrating portions of an exemplary remote operation and maintenance center, e.g., a communication device 201 in accordance with various exemplary embodiments will be discussed and described. The communication device 201 may include a controller 205, a transceiver 203, and optionally a communication port 211 for communication with an external device 209. The controller as depicted generally includes a processor 219, a memory 221, and may include other functionality not illustrated for the sake of simplicity. The communication device 201 may further include, e.g., a speaker 213, a microphone 215, a text and/or image display 207, an alerting device (not illustrated) for providing vibratory alert, visual alert, or other alert, and/or a user input device such as a keypad 217.

The processor 219 may comprise one or more microprocessors and/or one or more digital signal processors. The memory 221 may be coupled to the processor 219 and may comprise a read-only memory (ROM), a random-access memory (RAM), a programmable ROM (PROM), an electrically erasable read-only memory (EEPROM), and/or other memory types. The memory 221 may include multiple memory locations for storing, among other things, an operating system, data and variables 223 for programs executed by the processor 219; computer programs for causing the processor to operate in connection with various functions such as connecting to the OMC 225, transmitting location information 227, receiving base station parameters 229, modifying the parameters 231, and/or other processing (not illustrated); and a database 233 for temporarily storing the parameters that can be modified, and other information which may be used by the processor 219. The computer programs when executed by the processor 219 generally result in controlling the operation of the communication device 201.

The display 207 may present information to the user by way of a conventional liquid crystal display (LCD) or other visual display, and/or by way of a conventional audible device (e.g., the speaker 213) for playing out audible messages. The user may invoke one or more of various functions accessible through the user input device 217. The user input device 217 may comprise one or more of various known input devices, such as a keypad as illustrated, a computer mouse, a touchpad, a touch screen, a trackball, and/or a keyboard.

Responsive to signaling from the user input device 217, or in accordance with instructions stored in memory 221, the processor 219 may direct stored information or received information. For example, in response to receipt of parameters from the OMC, the processor 219 can update the display 207 to indicate the parameters. As another example, the processor 219 can be programmed or otherwise configured to, e.g., interact with the user, in order to make modifications to one or more parameters. Moreover, when one or more parameters are modified, the processor 219 can transmit modifications of the parameters over the transceiver 203.

The processor 219 may be programmed for connecting to the OMC 225. The communication device itself can initiate a connection that is to be established to the OMC-R, e.g., a remote log-in, a dial-up connection, a wireless connection, and the like. Alternatively, the OMC-R can initiate the connection that is to be established. Known techniques are appropriate for establishing a connection between the communication device and the OMC. If desired, identification and passwords or other authorization determinations can be utilized. One or more embodiments can provide an identification during, e.g., the establishment of the connection, where the identification corresponds to a particular security level, e.g., system operator level, manager level, user level, etc. and can be utilized to determine whether a particular modification of a particular parameters is allowed. Accordingly, in one or more embodiments, the establishing further includes authorizing an identification corresponding to a security level; and the communication device can determine whether the modifying of the parameter(s) is allowed responsive to the identification, and if not, disallowing the modifying.

The processor 219 can be programmed for transmitting location information 227. The location information can be obtained in any of several appropriate ways. For example, the location information can be obtained from a global positioning system (GPS) or similar system co-located on the communication device 201 and operatively connected to the processor 219. Accordingly, the location information can be determined responsive to a signal from a global positioning system in the communication device. In accordance with one or more alternative embodiments, the location information can be obtained from any information provided by one or more of the base stations in range of the communication device that can be utilized to determine location. For example, a triangulation can be provided in accordance with known techniques, and/or an identity of the base station in range corresponds to a location known to the communication network. Accordingly, the location can be indicative of at least one base station which is adjacent to the communication device. The location information can be transmitted from the communication device to the OMC, e.g., in a message.

Further in accordance with one or more embodiments, the processor 219 can be programmed for receiving base station parameters 229.

The parameters can be representative of at least one of transmit frequency, receive frequency, messaging information, power control, bandwidth allocation, traffic type, and reset. Generally, the communication device 201 can have access (subject to location restrictions) to any of the parameters utilized by the OMC. In accordance with one or more embodiments, the parameters provided to the communication device 201 or allowed to be modified can be a portion of the above-mentioned parameters. The parameters can be representative of one or more of the following which are conventionally provided, and as may be altered from time-to-time: controlling ACG (assignment coordination group), sector number of a containing cell, base radio number within the cell, ACG system release, base radio cabinet number, base radio position, hardware platform, transmit power, redundancy indication, number of carriers, base radio power reduction mode, WiDEN (Wideband iDEN) indicator, transmit frequency, and/or primary control channel.

In accordance with one or more embodiments, the processor 219 can be programmed for modifying the parameters 231. For example, the processor can be programmed to interact with a user, e.g., utilizing the display 207 and the keypad 217. An appropriate interface can resemble an interface utilized at the OMC for modifying parameters, e.g., can display current values of parameters for one or more base stations and/or cells relating to base stations, for the parameters received by the communication device 201, and can prompt a user for modifying one or more of the values of the parameters. Because the parameters are intended to affect the operation of one or more base stations that are in range of the communication device, and because one or more embodiments support communication between the OMC-R and the communication device via the communication network itself, it can be useful to prevent modifications that would result in the communication network dropping the communication device. For example, while the communication device is in a particular cell, parameters related to the cell's control channel can be read-only to prevent bringing down the control channel. Accordingly, the processor 219 can determine whether one or more modifications will adversely affect a communication between the communication device and the at least one base station, and if so, disallow the modifying

The communication device 201 can then transmit the modification of the parameters back to the OMC. The OMC can proceed to download the parameters to the base stations in accordance with its standard techniques. Generally, a base station can acknowledge that it received and/or that it successfully acted upon parameters which were downloaded to it. One or more embodiments of the present invention therefore provide that the OMC transmits a message, such as an acknowledge, back to the communication device to indicate the successful download of parameters. Accordingly, the processor 219 optionally can provide for receiving from the OMC a message indicating that the modification was effected at one or more base stations.

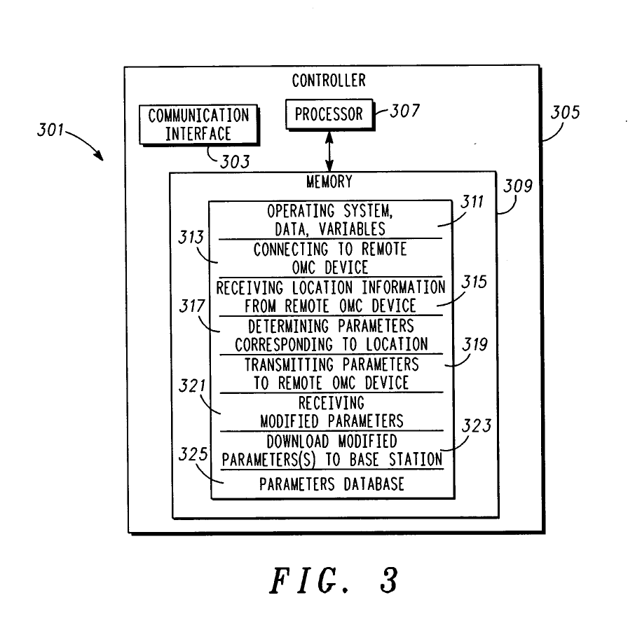

Referring now to FIG. 3, a block diagram illustrating portions of an exemplary infrastructure device, e.g., an operation and maintenance center, in accordance with various exemplary embodiments will be discussed and described. FIG. 3 is a diagram illustrating an operation and maintenance center (OMC) 301, forming a portion of an infrastructure device in an exemplary communication network. The OMC 301 may include one or more controllers 305, and a communication interface 303. The controller 305 as depicted generally comprises a processor 307, a memory 309, and may include various other functionality that is not relevant but will be appreciated by those of ordinary skill.

The processor 307 may comprise one or more microprocessors and/or one or more digital signal processors. The memory 309 may be coupled to the processor 307 and may comprise one or more of a read-only memory (ROM), a random-access memory (RAM), a programmable ROM (PROM), an electrically erasable read-only memory (EEPROM) and/or magnetic memory or the like. The memory 309 may include multiple memory locations for storing, among other things, an operating system, data and variables 311 for programs executed by the processor 307; computer programs for causing the processor to operate in connection with various functions such as connecting to the remote OMC device 313, receiving location information from the remote OMC device 315, determining parameters corresponding to the location 317, transmitting the parameters to the remote OMC device 319, receiving modified parameters from the remote OMC device 321, downloading the modified parameters to the base station 323, and/or other processing (not illustrated); and a database 325 of parameters, corresponding to the base stations in the communication network. Other database(s) can be provided if desired/needed for other information used by the processor 307. The computer programs when executed by the processor, generally direct the processor 307 in controlling the operation of the OMC 301.

The processor 307 may be programmed, for example, to connect or for connecting to the remote OMC device via the routine(s) 313. The connection between the OMC-R and a communication device, e.g., the remote OMC device 11 has been previously explained. It can be advantageous for the processor 307 to include an optional authentication of the communication device and/or to include a log-in procedure, so that only authorized users can access the OMC.

The processor 307 can be programmed for receiving location information from the remote OMC device via routine(s) 315. As explained previously, location information can include, for example, a GPS location, or the location can be indicative of one or more base stations which are adjacent to the communication device.

Also, the processor 307 can be programmed via the routine(s) 317 for determining parameters corresponding to the location. The processor 307 ordinarily includes or otherwise has access to a parameters database 325 having parameters corresponding to various base stations, generally representing the entire network. The format of the parameters database 325 is generally known in the industry; reference may be made, for example, to any commercially available OMC-R Configuration Management Parameters document. The parameters generally indicate information corresponding to a state of the base station. By utilizing the parameters database 325, the processor 307 can determine which base stations are adjacent to the location, for example, by determining which base stations are within a certain geographic distance from the location. If desired, the processor 307 can further determine which base stations are in range of the location. Accordingly, the parameters transmitted to the communication device correspond to a portion of a database 325, the database 325 including parameters representative of base stations comprising a wireless network, including the base station(s) that is to be modified.

The processor 307 further can be programmed for transmitting the parameters, which correspond to the base stations adjacent to the communication device, to the remote OMC device. Because the set of parameters sent to the communication device is limited, the set of parameters that can be modified by the communication device accordingly is limited. Moreover, if desired, the processor 307 can determine a subset of the set of parameters, e.g., by providing e.g., only transmit frequency and power control parameters.

Upon receipt of the parameters, the communication device can modify the parameters, and transmit them back to the OMC. Accordingly, the processor 307 also can be programmed for receiving modified parameters from the remote OMC device 319.

The processor 307 can update the parameters database 325 as is appropriate, for example, after verifying that the modification has been made at the base station.

Optionally, the connection to the communication device provides an identification, e.g., corresponding to a user and/or to a communication device. The identification can correspond to a particular security level, and the processor 307 can provide that various security levels have read/write or read-only access to various parameters. Accordingly, the processor 307 can authorize an identification corresponding to a security level; can determine whether the modification of the parameter(s) is allowed responsive to the identification, and if not, can disallow the modification. Disallowing the modification can include, e.g., transmitting an error message to the communication device, ignoring a particular disallowed modification, and/or ignoring communications including a disallowed modification.

In addition, one or more embodiments provide that the processor 307 determines whether the requested modification of parameters would adversely impact communication with the communication device. For example, if the modification would cause the base station currently supporting communication with the communication device to power down or to decrease a range of the base station, the modification can be disallowed. Accordingly, one or more embodiments can determine whether a communication between the communication device and the base station(s) will be impeded by the modification, and if so, disallow the modification.

Further, the processor 307 can be programmed for downloading the modified parameters to the base station 323. Advantageously, the parameters can be downloaded by the processor 307 to the base stations 323 in accordance with techniques currently known and used. However, it is not necessary to require approval or other action at the OMC in order to manually authorize the modifications.

As can be appreciated from the above discussion, various functions can be distributed between the OMC and the communication device. For example, both the OMC and the communication device can support the establishment of a connection between an operation and maintenance center (OMC) and a communication device. In accordance with various exemplary and alternative exemplary embodiments, one or the other, or even both, of the OMC and the communication device can be responsible for initiating the connection.

As another example, information is exchanged from the communication device to the OMC representative of a location of the communication device. The information can be provided explicitly by the communication device, e.g., by including location information provided by a GPS operably connected to the communication device. Alternatively, location information can be provided implicitly by the communication device, for example, indicated in a transmission from the communication network when the communication device is connected via the communication network. The location can be more precisely determined by the OMC based on the information transmitted by the communication device and/or acquired by the communication network in connection therewith.

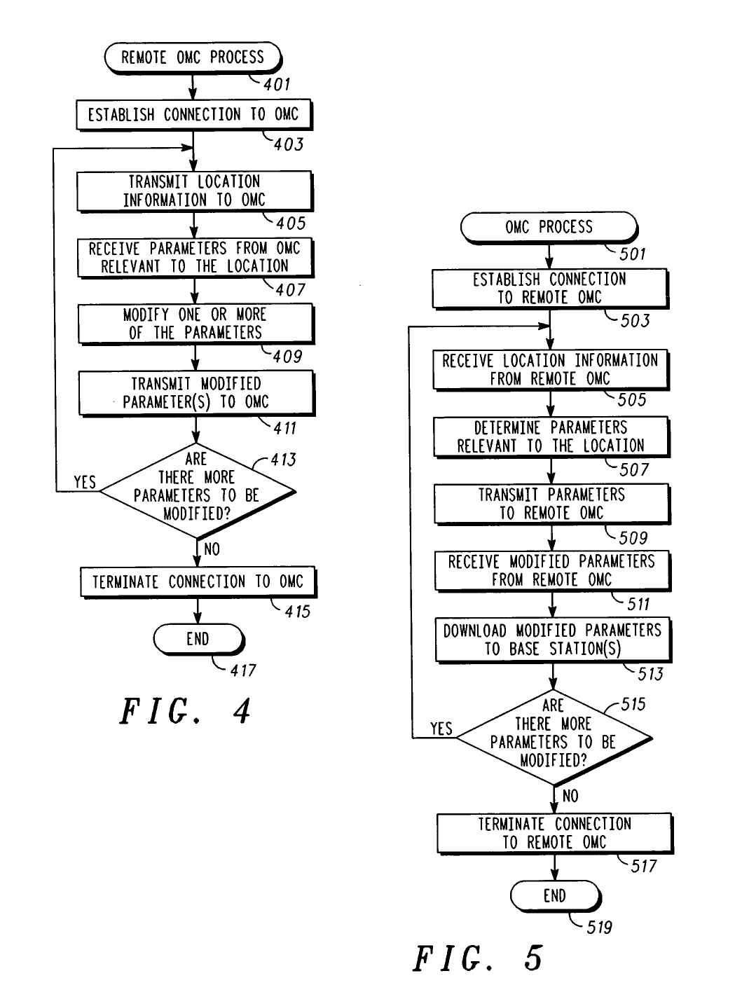

FIG. 4 and FIG. 5 provide exemplary flow charts illustrating respective processes corresponding to, e.g., the remote OMC, and the OMC itself.

Referring now to FIG. 4, a flow chart illustrating an exemplary remote operation and maintenance center process in accordance with various exemplary embodiments will be discussed and described. The procedure can advantageously be implemented on, for example, a processor of a remote OMC described in connection with FIG. 2 or other communication device appropriately arranged.

The remote OMC process 401 can provide for establishing 403 a connection to the OMC, for example as described previously herein. When the connection is established, the process can cause location information to be transmitted 405 to the OMC. The location information can be included in the transmission or can be otherwise associated with or available based on the transmission.

The process then provides for receiving 407 parameters from the OMC. The parameters which are received can be assumed to be relevant to the location of the remote OMC, or alternatively, the remote OMC can verify that the parameters relate to a base station adjacent to or disposed within an appropriate range of the remote OMC.

The process provides for modifying 409 one or more of the parameters. For example, the process can include an interaction with a user, e.g., via a user interface, to modify one or more of the parameters. This can include, if desired, a check of appropriate values for parameters. When one or more of the parameters are modified, the process can provide for transmitting 411 the modified parameter(s) to the OMC. This can be provided in a single transmission, or in multiple transmissions, if preferred.

The process can check 413 whether there are more parameters to be modified, e.g., by interacting with the user. If so, the process can loop back to continue modifications. In the illustrated flow chart, to accommodate a possibly mobile remote, the process loops back to again transmit 405 location information and receiving relevant parameters, before commencing with modifying the parameters.

If the process has no further parameters to be modified, then the process can terminate 415 the connection to the OMC, and end 417 the process. Optionally, the parameters can be erased from the memory or otherwise made unavailable, upon termination. Optionally, certain of the parameters can be stored in a memory for use in connection with a later parameter modification. This can be appropriate for example where parameters change infrequently, however, it may be desirable to verify the accuracy of parameters upon establishing a connection to the OMC. Note that the process 401 may be repeated as needed.

Referring now to FIG. 5, a flow chart illustrating an exemplary operation and maintenance center process 501 in accordance with various exemplary and alternative exemplary embodiments will be discussed and described. The process can advantageously be implemented on, for example, a processor of an OMC, described in connection with FIG. 3 or other apparatus appropriately arranged.

The process can include establishing 503 a connection to the remote OMC, as previously explained. The process can provide for receiving 505 location information from the remote OMC, and in response to the location information, determining 507 parameters relevant to that location, e.g., corresponding to base stations that are adjacent to that location.

The process can transmit 509 the parameters to the remote OMC. Any of numerous appropriate protocols can be utilized to ensure the accurate transmission. The process can then await receipt 511 of modified parameters (if any) from the remote OMC. Having received one or more modified parameters, the process provides for downloading 513 the modified parameters to the relevant base station(s)

The process can check 515 whether there are more parameters to be modified, e.g., where additional transmissions are received from the remote OMC. If there are more modifications, the process can (optionally) loop back to receive location information from the remote 405, determine 507 the relevant parameters, transmit 509 the parameters to the remote OMC, and receive 511 modified parameters.

If there are no further parameters to be modified, or for example in the event of a time-out, the process can provide for terminating 517 the connection to the OMC, and ending 519 the process. However, note that the process may be repeated as needed.

There have been described herein by way of example one or more embodiments to improve the process of managing communication network performance via a communication device in connection with an OMC, wherein the communication device advantageously can be operated in the field. The communication device can change various location-specific parameters, thereby reducing the need for field engineers to relay information back and forth with the system operators. Various changes to parameters can be disallowed based on, e.g., the location of the communication device.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore the wireless communication units or devices of interest may have short range wireless communications capability normally referred to as WLAN (wireless local area network) capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication units or devices of interest may be connected to a LAN using protocols such as TCP/IP, UDP/UP, IPX/SPX, or Net BIOS via a hardwired interface such as a cable and/or a connector.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of modifying at least one parameter of at least one base station, the method implemented in a communication device and comprising:
establishing a connection to an operation and maintenance center (OMC);
transmitting information to the OMC representative of a location of the communication device;
receiving a plurality of parameters from the OMC, the plurality of parameters being responsive to the location, the plurality of parameters having information corresponding to a state of at least one base station adjacent to the location;
modifying at least one parameter of the plurality of parameters to create at least one modification; and
transmitting the at least one modification to the OMC.

2. The method of claim 1, wherein the plurality of parameters are representative of at least one of transmit frequency, receive frequency, messaging information, power control, bandwidth allocation, traffic type, and reset.

3. The method of claim 1, further comprising determining the location responsive to a signal from a global positioning system in the communication device.

4. The method of claim 1, wherein the location is indicative of at least one base station which is adjacent to the communication device.

5. The method of claim 1, wherein the establishing further includes authorizing an identification corresponding to a security level; further comprising determining whether the modifying of the at least one parameter is allowed responsive to the identification, and if not, disallowing the modifying.

6. The method of claim 1, further comprising determining whether the at least one modification will adversely affect a communication between the communication device and the at least one base station, and if so, disallowing the modifying.

7. The method of claim 1, further comprising receiving from the OMC a message indicative that the modification was effected at the at least one base station.

8. A method of modifying at least one parameter of at least one base station, implemented in an operation and maintenance center (OMC), comprising:
establishing a remote connection to a communication device;
receiving information from the communication device representative of a location of the communication device;
determining a plurality of parameters corresponding to the location, the plurality of parameters having information corresponding to a state of at least one base station adjacent to the location;
transmitting the plurality of parameters to the communication device;
receiving a modification of at least one parameter of the plurality of parameters; and
downloading the at least one modification to the at least one base station.

9. The method of claim 8, wherein the plurality of parameters are representative of at least one of transmit frequency, receive frequency, messaging information, power control, bandwidth allocation, traffic type, and reset.

10. The method of claim 8, wherein the location is indicative of at least one base station which is adjacent to the communication device.

11. The method of claim 8, wherein the establishing further includes authorizing an identification corresponding to a security level; further comprising determining whether the modification of the at least one parameter is allowed responsive to the identification, and if not, disallowing the modification.

12. The method of claim 8, further comprising determining whether a communication between the communication device and the at least one base station will be impeded by the modification, and if so, disallowing the modification.

13. The method of claim 8, further comprising receiving from the at least one base station a message indicative that the modification was effected at the at least one base station.

14. A computer-readable medium comprising instructions being executed by a computer, the instructions including a computer-implemented method for modifying at least one parameter of at least one base station, the instructions for implementing the steps of:
establishing a connection between an operation and maintenance center (OMC) and a communication device;
first exchanging information from the communication device to the OMC representative of a location of the communication device;
second exchanging a plurality of parameters from the OMC to the communication device, the plurality of parameters having information corresponding to a state of at least one base station adjacent to the location;
third exchanging at least one modification, the modification reflecting a change to at least one parameter of the plurality of parameters; and
facilitating a download of the at least one parameter to the at least one base station.

15. The computer-readable medium of claim 14, wherein the plurality of parameters are representative of transmit frequency, receive frequency, messaging information, power control, bandwidth allocation, traffic type, and reset.

16. The computer-readable medium of claim 14, further comprising instructions for implementing the steps of first determining the location, and second determining the plurality of parameters to be exchanged in the second exchanging responsive to the location.

17. The computer-readable medium of claim 14, further comprising instructions for implementing the steps of first determining the location; second determining whether the modification of the at least one parameter is allowed responsive to the location; and if not, disallowing the modification.

18. The computer-readable medium of claim 17, wherein the second determining is further responsive to the at least one parameter.

19. The computer-readable medium of claim 14, further comprising instructions for implementing the step of fourth exchanging a confirmation that the modification was effected at the at least one base station.

20. The computer-readable medium of claim 14, wherein the plurality of parameters correspond to a portion of a database, the database including parameters representative of a plurality of base stations comprising a wireless network, including the at least one base station.
